(19) United States
(12) Patent Application Publication
(10) Pub. No.: US 2025/0040498 A1
(43) Pub. Date: Feb. 6, 2025

(54) MACHINE LEARNING DEVICE FOR CROP WATER OPTIMIZATION

(71) Applicant: Brad Wu, Chandler, AZ (US)

(72) Inventor: Brad Wu, Chandler, AZ (US)

(21) Appl. No.: 18/582,975

(22) Filed: Feb. 21, 2024

Related U.S. Application Data
(60) Provisional application No. 63/530,430, filed on Aug. 2, 2023.

(51) Int. Cl. A01G 25/16; G06T 7/00; G06V 10/82; G06V 20/10

(52) U.S. Cl. CPC A01G 25/167; G06T 7/0012; G06V 10/82; G06V 20/188; G06T 2207/20081; G06T 2207/20084; G06T 2207/30188

(57) ABSTRACT

A machine learning device and method for managing water provision to crops by learning and detecting plant stages. The device includes sensors for measuring environmental parameters, a camera for capturing images of the plant stage, an observation unit for defining a feature map of observable variables and evaluating captured data, a learning unit for comparing captured data against training data and learning the plant stage, and a watering mechanism. The device can be connected to a microcontroller with a wireless module for data transmission. The method involves capturing images of a plant at different growth stages, analyzing the image to detect the growth stage, training a learning unit to recognize the different growth stages, and adjusting the water provided to the plant based on its growth stage. The device and method can be used for managing water provision to multiple types of plants.

### CROSS REFERENCE

This application claims benefit from currently pending U.S. Provisional Application No. 63/530,430 titled “A Machine Learning Device for Crop Water Optimization” and having a filing date of Aug. 2, 2023, and all of which is incorporated by reference herein.

### FIELD OF THE INVENTION

The present specification relates generally to devices for watering a crop and more specifically a system that uses machine learning to detect growth stages of a plant and take the growth stage and environmental conditions to adjust watering of the crop.

### BACKGROUND OF THE INVENTION

Water and water conservation has become increasingly more important as climate changes and unprecedented drought conditions are happening worldwide. For example, 2022 was characterized by extreme drought throughout the world. Water consumption is of profound interest to farmers and those individuals use water for their agriculture needs. The extent and frequency of watering can vary from crop to crop and is essential for the crop to grow efficiently. A crop can be affected by a number of factors including climate and soil water. One example farmers use is the crop water stress index (“CWSI”) which ascertain the logistic associated to plant-stressing. When a CWSI is zero it represents a well-watered, healthy plant. Soil water and proper irrigations scheduling is based on the water content of the crop. Users have used the CWSI to determine the health of the plants, but this type of data is limited to what CWSI and not to the actual conditions of each plant.

The efficient management of water resources in agriculture is a critical aspect of sustainable farming. This is particularly true in regions where water scarcity is a significant issue. Traditional methods of irrigation management often rely on manual observation and intervention, which can be labor-intensive and imprecise. Furthermore, these methods may not take into account the specific needs of individual plants or crops at different stages of their growth cycle. The advent of machine learning and artificial intelligence technologies has opened up new possibilities for automating and optimizing irrigation management. However, existing solutions often lack the ability to accurately detect and respond to the specific needs of individual plants or crops. For instance, they may not be able to accurately determine the growth stage of a plant and adjust the irrigation accordingly.

As a crop grows over a period of time a visual indication of the plant's health can typically be determined by the leaf's health. For example, a healthy plant stretches up towards the sun, and an unhealthy plant wilts, drops or curls with discoloration. Most devices today only look at the environmental conditions of the plant to determine whether it needs watering, or they look at hourly water usage and consumption. Hourly usage only takes into account the flow rate and the amount of water passed through the flow meter to determine plant water usage. This type of usage can stress plants out because of over watering. This type of method relates to the cumulative water usage for the crop which is determined by how much water flows to the crop and the soil conditions after the water flows to the crop. Other devices use environmental conditions which can be used to determined how much rain the plant has seen and the soil condition such as moisture levels. These types of methods waste water and do not determine the health of the plant within the crop. A plant requires more or less water at its varying growth stages it goes through and can require more or less watering in higher or lower temperatures and varying climates. Current systems do not take into account the varying plant stages along with the environmental conditions the plants will see to determine the amount of water the plant will need.

Therefore, there is a need for a machine learning system that can learn the varying stages of plants and use those stages and the environmental conditions the plant will see to determine the amount of water needed for each type of plant. Such a device would significantly improve the efficiency and effectiveness of irrigation management, leading to better crop yields and more sustainable farming practices.

### BRIEF SUMMARY OF THE INVENTION

Accordingly, the present invention is a plant stage machine learning device for learning a plant stage and detecting the plant stage within a crop can comprise at least one sensor for measuring environmental parameters related to the plant stage. The device can have at least one camera configured to capture images of the plant stage. An observation unit can observe a variable obtained based on information from the at least one sensor and the at least one camera. A learning unit can learn the plant stages based on detecting the information created from the at least one sensor and at least one camera based on training data created from the output of the observation unit and data related to detect the plant stage. The device can further have a watering mechanism.

The machine learning device can have at least one sensor wherein the at least one of a temperature sensor, a moisture sensor, a rain sensor, a humidity sensor, and volumetric moisture sensor. The machine learning device can further comprise training data wherein the data related to an image of the crop from the at least one camera which is the image of the actual crop at its various growth stages. The teacher data can be data related to a trained image of the crop which is an image of the crop in its different growth stages. The information about the plant stage can be germination, emergence, flow bud formation, early bloom, peak bloom, fruit formation, fruit development and harvest.

The water mechanism can be a water pump, water valve or irrigation valve that is remotely controlled by the machine learning device to allow or stop water to flow to the crop. The at least one sensor and at least one camera can be connected to a microcontroller having a wireless module wherein the wireless module sends and receives data from the machine learning device. The machine learning device can be on a cloud server or on a microcontroller unit. The at least one camera can be such as, for example, Wi-Fi enabled camera, ESP32-CAM, mini-camera, or digital camera. The at least one camera can capture an image of the crop at different periods of time between plant stage. The machine learning device can be connected to other machine learning devices that can control multiple crops. The machine learning device can comprise a neural network.

The method for managing water providing to a crop of individual plants includes capturing images of a plant at its different growth stages, analyzing the image and detecting the growth stage that the plant is in, training a learning unit to recognize the different growth stages of the plant wherein the learning unit recognizes the growth stage of the plant, and adjusting the water provided to the plant based on the growth stage of the plant. The learning unit receives data from at least one sensor and can determine a growth rate based on the growth stages of the plant over time and determine how much water is needed based on the growth rate and the current growth stage for that individual plant wherein the at least one sensor detects environmental conditions for the plant. The method can also include analyzing and controlling an irrigation system based on the captured images and environmental conditions. The machine learning device can learn the growth stage and environmental conditions for more than one type of plant.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 depicts a flow chart of a machine learning device for crop optimization in accordance to one, or more embodiments;

FIG. 2 depicts different plant stages in accordance to one, or more embodiments;

FIG. 3 depicts machine learning convolutional neural network to detect plant growth stages in accordance to one, or more embodiments;

FIG. 4 depicts neural network to train the dataset for the machine learning for crop optimization in accordance to one, or more embodiments;

FIG. 5 depicts image detection and machine learning object detection of a machine learning device in accordance to one, or more embodiments; and

FIG. 6 depicts a low power solution for a machine learning device in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

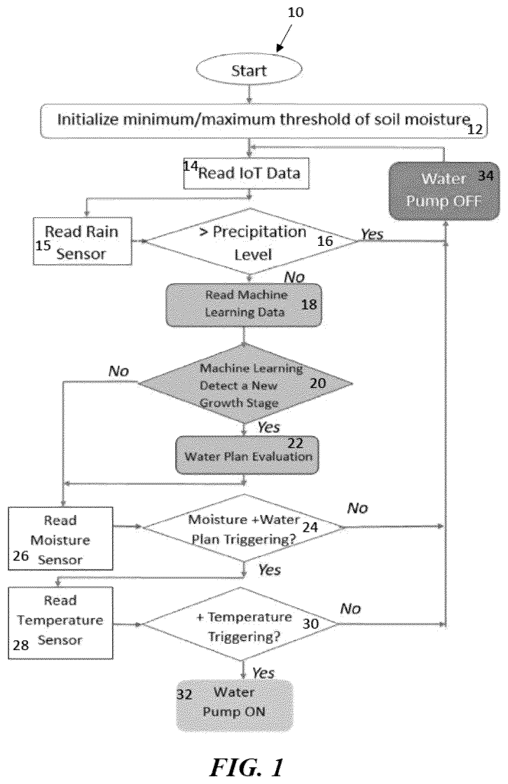

Referring initially to FIG. 1 which depicts a flow chart of a machine learning device for crop optimization shown generally at 10. A plant stage machine learning device for learning a plant stage and detecting the plant stage within a crop can comprise at least one sensor for measuring environmental parameters related to the plant stage wherein the at least one sensor can be at least one of such as, for example, a temperature sensor 28, a moisture sensor 26, a rain sensor 15, a humidity sensor, and volumetric moisture sensor. These sensors are designed to measure various environmental parameters that are critical to the growth and development of the plant. The temperature sensor 28 measures the ambient temperature in the vicinity of the plant, while the moisture sensor measures the moisture content in the soil where the plant is growing. The rain sensor 15 detects the presence of rainfall, and the humidity sensor measures the humidity level in the air. The volumetric moisture sensor 26 measures the volume of water in the soil, providing a more accurate assessment of the soil's water content.

The machine learning device can initialize and can detect the minimum or maximum threshold of the soil moisture 12 that the plant or crop is in, which can be determined by new reading from the at least one sensor or an old reading taken previously from the at least one sensor or user input for that particular plant type. The machine learning device can read the data 14 from the at least one sensor by such as, for example, wireless signal, long-range Wi-Fi, wired signal, cellular signal, satellite signal, or the like.

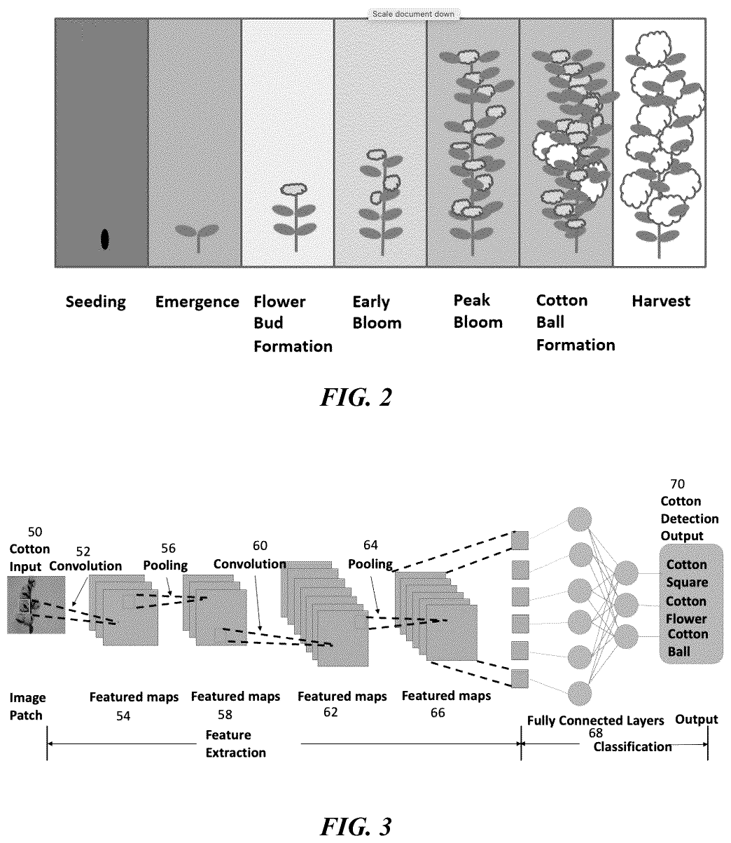

The machine learning device can have at least one camera configured to capture at least one image of the plant stages wherein the plant stages can be such as, for example, seeding, emergence, flow buds formation, early bloom, peak bloom, fruit formation/cotton ball formation, fruit development and harvest as shown in FIG. 2. Referencing FIG. 3, a machine learning device can be an observation unit which can observe a variable obtained based on information from the at least one sensor and/or the at least one camera. The observation unit can take an image patch 50 of the plant and convolute 52 the image from a past plant image crating a feature map 54. The feature maps can be pooled 56 together creating another feature map 58 and this process can be repeated 60, 62, 64, 66 to create a fully connected layer map 68 of the plant image over a period of time or over a certain instance creating training data creating a neural network architecture to detect plant growth. The fully connected layers 68 can output the plant stage and classify the plant in one of its stages and then the detection is outputted. For example, cotton detection output can be a cotton square, cotton flower, or cotton ball at 70.

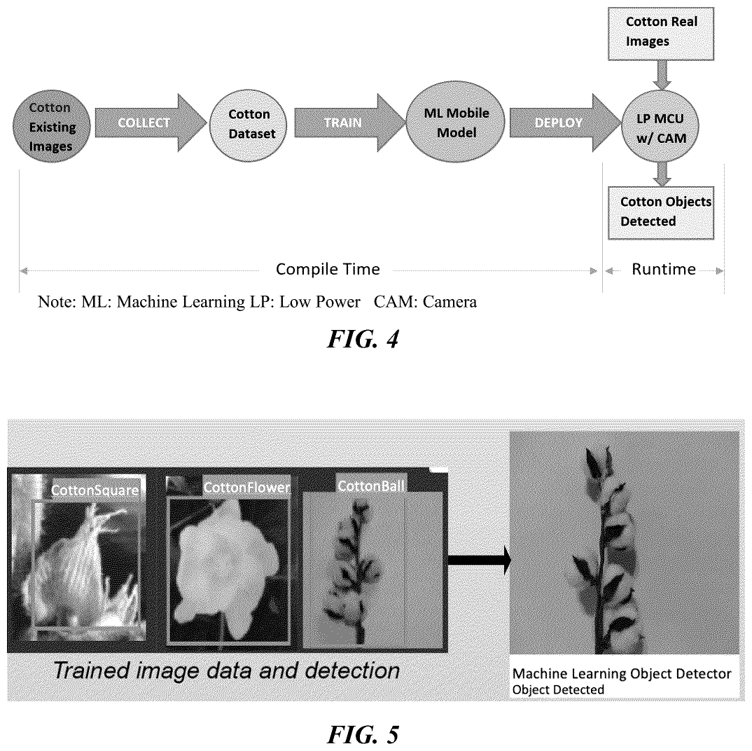

Referring to FIG. 4, the teacher data can be data or an example giving to the machine learning device that can learn and compare to related to a trained image of the crop which can be an image of the crop in its different growth stages. The teacher data can be information about the plant stage such as, for example, germination, leaf development, formation of side shoots, stem elongation, vegetative plant parts, inflorescence emergence, flowering, and fruit development.

The machine learning device can comprise a neural network. The machine learning device can have a compile time and a runtime wherein the compile time comprises taking the exiting cotton images, collecting the image and analyze that image dataset to a set of images at the different growth stages, and then train the ML mobile model and then deploy into the runtime wherein the runtime comprises looking at the plant's real images taken by the low powered MCU and comparing them with the plant's object detected by the low powered MCU with Camera. The machine learning device may be located on a cloud server or on a microcontroller unit. The cloud server provides the advantage of high computational power and large storage capacity, while the microcontroller unit provides the advantage of being located close to the plant, reducing the latency of data transmission. The machine learning device may further comprise a transceiver to network with at least one other machine learning device that controls at least one different crop. This allows for the sharing of data and learning between different machine learning devices, improving the overall performance of the system.

The training data can be the image of the crop from the at least one camera which is the image of the actual crop at its various growth stages. The training data can be taken at the various growth stages of the plant and can train the machine learning device to recognize the different growth stages as shown in FIG. 5. A learning unit can learn these plant stages based on detecting the information created from the at least one sensor and at least one camera which can be based on the training data created from the output of the observation unit and data related to detect the plant stage.

Referring back to FIG. 1, the machine learning device can further have a watering mechanism wherein the water mechanism can be turned on 32 or turned off 34 depending on the machine learning data and the data received from the at least one sensor. The water mechanism can be such as, for example, a water pump, water valve or irrigation valve which can be controlled by such as, for example, remotely, wired, or the like. The machine learning device can control the water mechanism controlling the amount of water that the crop or individual plant will see. Once the data is read 14, the rain sensor can be read and the precipitation level 16 is compared to the plant stage wherein the machine learning device reads the learning data 18 and compares it to the teacher data to see if the current plant is at a new growth stage 20 or at the same growth stage if it is then the water plan is evaluated and readjusted according to the plant stage and then adjusted according to the environmental conditions. For example, if the plant is at the same growth stage then the moisture level is read 26 and the moisture and watering plan is triggered 24 indicating that it potentially needs water wherein the temperature is then read 28. If each of these factors indicate that the plant or crop needs water then the device is trigger 30 and the watering mechanism is turned on 32, or if any factors indicate that the plant or crop is in the acceptable range then the watering mechanism remains off 34.

In embodiments, the at least one sensor and at least one camera can be connected to a microcontroller unit (“MCU”) having a wireless module wherein the wireless module can send and receive data from the machine learning device which can control and relay data from at least one of such as, for example, water mechanism, sensor, camera, or the like. In the preferred embodiment the machine learning device can be on a cloud server but in other embodiments it can be on an MCU. The at least one camera can be such as, for example, Wi-Fi enabled camera, ESP32-CAM, mini-camera, or digital camera. The at least one camera can capture an image of the crop at different periods of time between plant stage. The machine learning device can be connected to other machine learning devices and multiple MCUs that can control multiple crops or individual plant waterings.

In embodiments, a machine learning device method for detecting a plant stage can comprise capturing images of a plant at its different growth stages which it can then analyze using image patch, convolutions, featured maps, pooling and then connected the layer to get a output of the images which can then detect the growth stage that each plant is in. The method can further comprise training a learning unit to recognize the different growth stages of the plant wherein the learning unit can recognize such as, for example, germination, leaf development, formation of side shoots, stem elongation, vegetative plant parts, inflorescence emergence, flowering, and fruit development.

The machine learning device can adjust the water flow using the water mechanism to each crop or plant for the different growth stages. The learning unit can compare the at least one sensor with the growth rate to determine how much water is needed at the different growth stages for that particular plant wherein the sensors can detect the environmental conditions for the plant allowing the learning unit to analyze and adjust the watering for the plant stage and environmental condition. The machine learning device can comprise a method for analyzing and controlling the irrigation system based on the environmental conditions and captured images. The machine learning device can learn the growth stage and environmental conditions for more than type of plant which can be such as, for example, cotton, soybeans, potatoes, corn, wheat, sugar beets, tomatoes, grapes, apples, lettuce, or the like and can adjust watering accordingly to each type of plant and its growth stage.

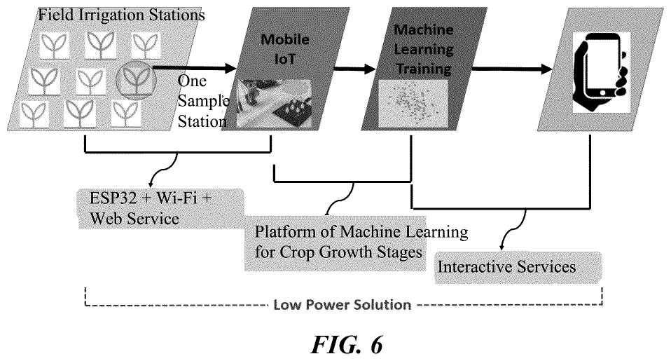

FIG. 6 depicts a low power machine learning device wherein the device can comprise of a mobile internet of things device or low powered MCU 100 at a field irrigation station 102 wherein the internet of things device can be such as, for example a ESP32 module, or any suitable low powered MCU or the like having a wireless module which can be such as, for example, cellular module, Wi-Fi, Bluetooth, or the like that can be connected to a web server or cloud platform remotely. The cloud platform or web-based server can comprise the machine learning device for crop growth stages 104 wherein the internet of things device can communicate remotely to the machine learning device. The user can use a portable computing device 106 to be notified of the parameters of the machine learning device such as, plant growth stage, and environmental conditions.

The machine learning device can learn the growth stage and environmental conditions for more than one type of plant. This makes the device versatile and capable of managing a wide variety of crops. The machine learning device can be trained on different types of plants, allowing it to recognize the growth stages and water needs of each type of plant. This makes the device a powerful tool for managing water resources in a diverse agricultural setting.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1-11. (canceled)

12. A method for managing water providing to a crop of individual plants, the method comprising:
capturing a first image patch of a plant;
capturing a second image patch of the plant and convoluting the second image patch with the first image patch to create a feature map of the plant;
capturing a plurality of subsequent image patches and convoluting the plurality of subsequent image patches with the feature map to create a layer map of the plant over a period of time;
classifying the plant in a growth stage based on the layer map;
training a learning cloud server or microcontroller unit to recognize the different growth stages of the plant wherein the learning unit recognizes the growth stage of the plant; and
adjusting the water provided to the plant based on the growth stage of the plant.

13. The method of claim 12, wherein the learning cloud server or microcontroller unit receives data from at least one sensor and wherein the learning unit can determine a growth rate based on the growth stages of the plant over time and determine how much water is needed based on the growth rate and the current growth stage for that individual plant, and wherein the at least one sensor detects environmental conditions for the plant.

14. The method according to claim 13, further comprising analyzing and controlling an irrigation system based on the captured images and environmental conditions.

15. The machine learning device according to claim 14, wherein the machine learning device learns the growth stage and environmental conditions for more than one type of plant.
